(19) United States
(12) Patent Application Publication
(10) Pub. No.: US 2021/0299792 A1
(43) Pub. Date: Sep. 30, 2021

(54) MACHINING APPARATUS, METHOD FOR IDENTIFYING RELATIVE POSITIONAL RELATIONSHIP, AND METHOD FOR DETERMINING LASER LIGHT QUANTITY

(71) Applicant: National University Corporation Tokai National Higher Education and Research System, Nagoya-shi Aichi (JP)

(72) Inventor: Eiji SHAMOTO, Nagoya-shi Aichi (JP)

(21) Appl. No.: 17/196,441

(22) Filed: Mar. 9, 2021

Related U.S. Application Data
(63) Continuation of application No. PCT/JP2020/014710, filed on Mar. 30, 2020.

(51) Int. Cl. B23K 26/38; B23K 26/082; B23K 26/08; B23K 26/70

(52) U.S. Cl. CPC B23K 26/38; B23K 26/705; B23K 26/083; B23K 26/082

(57) ABSTRACT

A feed mechanism moves a workpiece relative to a cylindrical irradiation region of laser light. A light receiver receives laser light that has not impinged on the workpiece. An intensity detector detects intensity of the laser light received. A controller identifies a relative positional relationship between the laser light and the workpiece on the basis of the light intensity detected. The controller determines, at timing when the light intensity detected decreases, that the laser light has begun to cut into the workpiece.

### CROSS REFERENCE TO RELATED APPLICATIONS

This application is based upon and claims the benefit of priority from International Application No. PCT/JP2020/014710, filed on Mar. 30, 2020, the entire contents of which are incorporated herein by reference.

### BACKGROUND

### 1. Field of the Disclosure

The present disclosure relates to a technique for identifying a relative positional relationship between laser light and a workpiece and/or a technique for monitoring machining with laser light.

### 2. Description of the Related Art

As a machining method using laser light, pulse laser grinding is known in which surface machining is performed by concentrating pulse laser light and scanning a cylindrical irradiation region including a focused spot over a surface of a workpiece.

JP 2016-159318 A discloses a method of overlapping an irradiation region of pulse laser light that extends in a cylindrical shape and has energy enough to make machining with a surface-side portion of a workpiece and scanning the irradiation region at a speed that allows machining to remove a surface region of the workpiece.

Hiroshi Saito, Hongjin Jung, Eiji Shamoto, Shinya Suganuma, and Fumihiro Itoigawa; “Mirror Surface Machining of Steel by Elliptical Vibration Cutting with Diamond-Coated Tools Sharpened by Pulse Laser Grinding”, International Journal of Automation Technology, Vol. 12, No. 4, pp. 573-581 (2018) discloses a technique of machining a flank face of a tool base material in two directions by pulse laser grinding to form a V-shaped cutting edge.

FIGS. 1A and 1B are diagrams for describing a method of sharpening a cutting edge of a diamond-coated tool by pulse laser grinding disclosed in “Mirror Surface Machining of Steel by Elliptical Vibration Cutting with Diamond-Coated Tools Sharpened by Pulse Laser Grinding”. FIG. 1A shows a state where a rake face is subjected to pulse laser grinding, and FIG. 1B shows a state where a flank face is subjected to pulse laser grinding in two directions. The use of pulse laser grinding allows the cutting edge to be sharpened by causing laser light to slightly cut into the tool cutting edge and applying a feed motion along the cutting edge ridgeline between the laser light and the tool.

The technique for detecting that the laser light has cut into the tool cutting edge has not been developed, so that the laser grinding has not been automated yet. At present, a worker confirms that the laser light impinges on the tool cutting edge by confirming plasma, generated at the time of a slight cut, by a visual check or by using an image captured by a camera. It is therefore desired to develop a technique for identifying, during laser grinding process, a relative positional relationship between the laser light and the workpiece. It is also desired to develop a technique for monitoring laser grinding process.

### SUMMARY

The present disclosure has been made in view of such circumstances, and it is therefore one object of the present disclosure to provide a technique for identifying a relative positional relationship between laser light and a workpiece during laser grinding process. Further, another object of the present disclosure is to provide a technique for monitoring laser grinding process.

In order to solve the above-described problem, a machining apparatus according to one aspect of the present disclosure is structured to scan a cylindrical irradiation region including a focused spot of laser light to machine a workpiece and includes a feed mechanism structured to move the workpiece relative to the cylindrical irradiation region of the laser light, a light receiver structured to receive laser light that has not impinged on the workpiece, an intensity detector structured to detect intensity of the laser light received, and a controller structured to identify a relative positional relationship between the laser light and the workpiece on the basis of the light intensity detected.

A machining apparatus according to another aspect of the present disclosure is structured to scan a cylindrical irradiation region including a focused spot of laser light to machine a workpiece and includes a feed mechanism structured to move the workpiece relative to the cylindrical irradiation region of the laser light, a light receiver structured to receive laser light that has not impinged on the workpiece, an intensity detector structured to detect intensity of the laser light received, and a controller structured to determine a quantity of laser light used for machining the workpiece on the basis of the light intensity detected.

Yet another aspect of the present disclosure is a method for identifying, in a machining apparatus structured to scan a cylindrical irradiation region including a focused spot of laser light to machine a workpiece, a relative positional relationship between the laser light and the workpiece, the method including moving the workpiece relative to the cylindrical irradiation region of the laser light, receiving laser light that has not impinged on the workpiece, detecting intensity of the laser light received, and identifying the relative positional relationship between the laser light and the workpiece on the basis of the light intensity detected.

Yet another aspect of the present disclosure is a method for determining, in a machining apparatus structured to scan a cylindrical irradiation region including a focused spot of laser light to machine a workpiece, a quantity of laser light, the method including moving the workpiece relative to the cylindrical irradiation region of the laser light, receiving laser light that has not impinged on the workpiece, detecting intensity of the laser light received, and determining a quantity of laser light used for machining the workpiece on the basis of the light intensity detected.

### BRIEF DESCRIPTION OF THE DRAWINGS

FIGS. 1A and 1B are diagrams for describing a method of sharpening a cutting edge of a diamond-coated tool by pulse laser grinding;

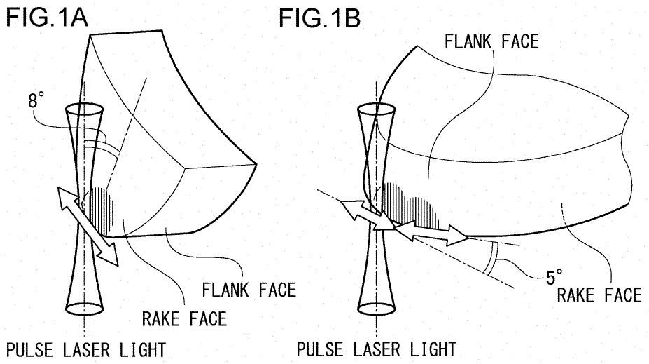

FIG. 2 is a diagram for describing pulse laser grinding;

FIG. 3 is a diagram schematically showing a structure of a laser machining apparatus;

FIGS. 4A to 4C are diagrams for describing an origin setting process;

FIG. 5A is a diagram showing changes in feed amount over time during the origin setting process, and FIG. 5B is a diagram showing changes in light intensity over time during the origin setting process; and

FIG. 6A is a diagram showing how the pulse laser grinding is performed, and FIG. 6B is a diagram showing changes in light intensity over time during the pulse laser grinding.

### DETAILED DESCRIPTION

The disclosure will now be described by reference to the preferred embodiments. This does not intend to limit the scope of the present disclosure, but to exemplify the disclosure.

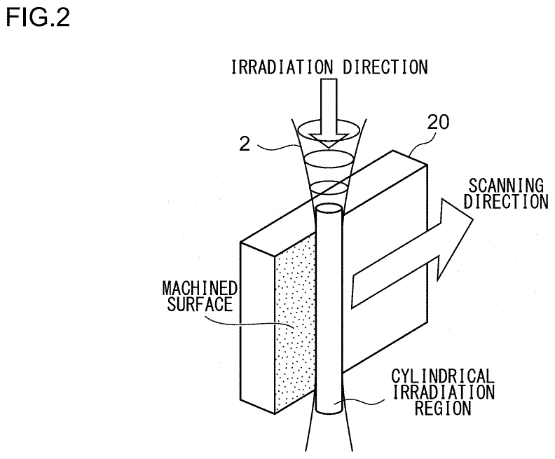

FIG. 2 is a diagram for describing pulse laser grinding. As disclosed in JP 2016-159318 A and Hiroshi Saito, Hongjin Jung, Eiji Shamoto, Shinya Suganuma, and Fumihiro Itoigawa; “Mirror Surface Machining of Steel by Elliptical Vibration Cutting with Diamond-Coated Tools Sharpened by Pulse Laser Grinding”, International Journal of Automation Technology, Vol. 12, No. 4, pp. 573-581 (2018), the pulse laser grinding is a machining method of overlapping a cylindrical irradiation region extending in an optical axis direction of laser light 2 and having energy enough to make machining with a surface of a workpiece 20 and scanning the cylindrical irradiation region in a direction intersecting the optical axis to remove a surface region of the workpiece 20 where the cylindrical irradiation region has passed. In the pulse laser grinding, a plane parallel to the optical axis direction and scanning direction is formed on the surface of the workpiece 20.

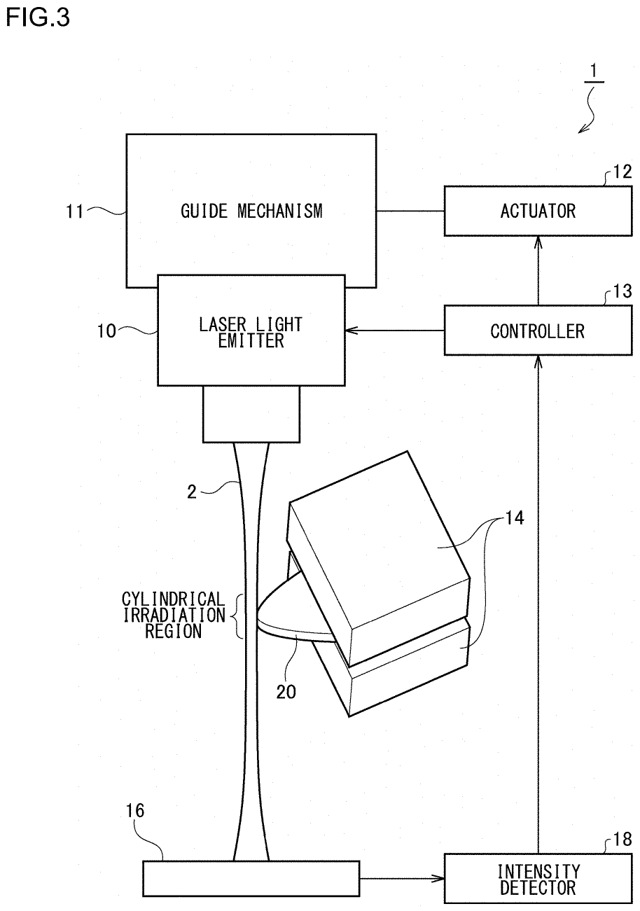

FIG. 3 shows a schematic structure of a laser machining apparatus 1 structured to perform pulse laser grinding. The laser machining apparatus 1 includes a laser light emitter 10 that emits laser light 2, a support device 14 that supports the workpiece 20, a guide mechanism 11 that allows the laser light emitter 10 to move relative to the workpiece 20, an actuator 12 that allows predetermined movement along the guide mechanism 11, and a controller 13 that collectively controls operation of the laser machining apparatus 1. The guide mechanism 11 and the actuator 12 serve as a feed mechanism that moves the workpiece 20 relative to the cylindrical irradiation region of the laser light 2. According to the embodiment, the workpiece 20 is a cutting tool, and the laser machining apparatus 1 performs pulse laser grinding to sharpen a cutting edge of the cutting tool, but the workpiece 20 may be an object of a different type.

The laser light emitter 10 includes components such as a laser oscillator that generates laser light, an attenuator that adjusts output of the laser light, and a mirror that changes a direction of the laser light and is structured to concentrate, through an optical lens, and emit the laser light 2 that has passed through the components. For example, the laser oscillator may generate Nd: YAG pulse laser light.

The feed mechanism according to the embodiment changes the location of the laser light emitter 10 relative to the workpiece 20 and may further include a mechanism for changing a relative position of the laser light emitter 10. The actuator 12 makes desired relative movement in response to a command from the controller 13 to change the location of the laser light emitter 10 relative to the workpiece 20 and change, as needed, the relative position of the laser light emitter 10. Note that, in the laser machining apparatus 1 shown in FIG. 3, the guide mechanism 11 changes the location of the laser light emitter 10, and, as needed, the position of the laser light emitter 10, but when it is preferable that the laser light emitter 10 be stationary, the support device 14 may be changed in location, and, as needed, in position. In any case, the feed mechanism includes a mechanism for moving the workpiece 20 relative to the cylindrical irradiation region of the laser light 2 and changing, as needed, the relative position of the workpiece 20.

The laser machining apparatus 1 according to the embodiment includes a light receiver 16 that receives laser light that is emitted from the laser light emitter 10 and passes by the workpiece 20 without impinging on the workpiece 20. The light receiver 16 is disposed facing a laser light emission port and at a predetermined distance from the laser light emission port. When the laser light emitter 10 is moved by the feed mechanism, the light receiver 16 is moved together with the laser light emitter 10 while maintaining the relative positional relationship with the laser light emitter 10.

Since the pulse laser grinding is a machining method in which a plane parallel to the optical axis direction and scanning direction of the laser light 2 is formed on the surface of the workpiece 20, only some of the laser light 2 is used for eliminating the material of the workpiece 20, and most of the laser light 2 passes by without impinging on the workpiece 20. This causes the light receiver 16 according to the embodiment to receive the laser light 2 that has passed by without being used for machining the workpiece 20. An intensity detector 18 detects intensity of the laser light received by the light receiver 16. The light receiver 16 and the intensity detector 18 may be provided separately, or alternatively, may be provided as a single unit.

The laser light 2 used for pulse laser grinding is emitted so as to be focused near the workpiece 20 and thus becomes the highest in energy density near the workpiece 20. In order to prevent damage to and deterioration of the light receiver 16, it is preferable that the light receiver 16 be installed at some distance from the focused cylindrical irradiation region. For example, when the distance between the optical lens that concentrates the laser light of the laser light emitter 10 to the workpiece 20 is denoted by L, it is preferable that the distance from the workpiece 20 to the light receiver 16 be set equal to or greater than L, that is, be set equivalent to L.

When the laser machining apparatus 1 moves the cylindrical irradiation region of the laser light 2 to cause the cylindrical irradiation region to gradually cut (deep cut) into the workpiece 20, accurately identifying the relative position (origin) at the moment when the cutting begins allows the workpiece 20 to be machined by an accurate elimination amount (depth of cut). Therefore, the laser machining apparatus 1 according to the embodiment has a capability (origin setting capability) of identifying, before performing the pulse laser grinding, the relative position at the moment when the laser light 2 begins to cut into the workpiece 20 on the basis of the light intensity detected by the intensity detector 18.

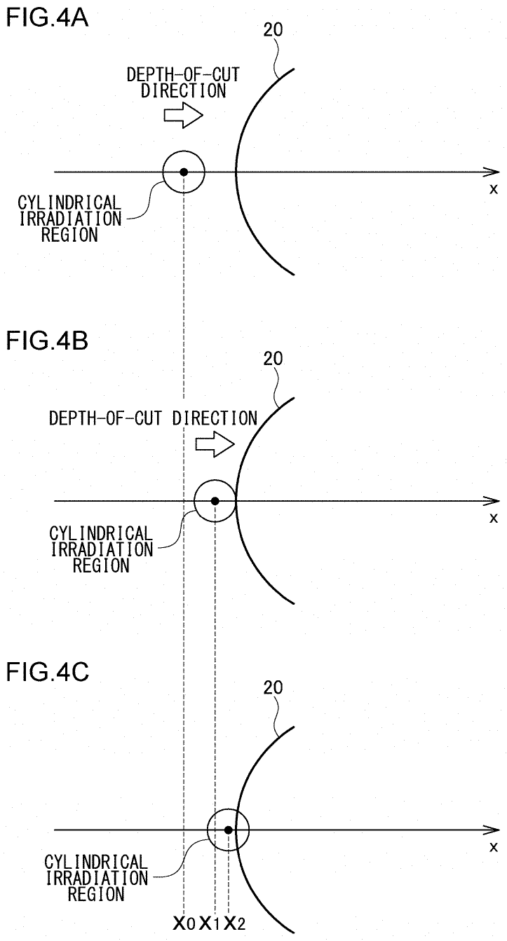

FIGS. 4A to 4C are diagrams for describing the origin setting process in the laser machining apparatus 1. FIGS. 4A to 4C show how the feed mechanism moves the laser light 2 in a direction in which the laser light 2 cuts into (moves toward) the workpiece 20, but, in practice, the feed mechanism may move the workpiece 20 in a direction in which the workpiece 20 moves toward the laser light 2. Herein, a feed direction is the x-axis positive direction, and a traveling speed v is constant.

FIG. 4A shows a state where the x-coordinate of the optical axis center of the laser light 2 is at an initial position x₀. From this state, the feed mechanism moves the laser light 2 in the depth-of-cut direction at the constant speed v. FIG. 4B shows a state at the moment when the outermost peripheral portion of the cylindrical irradiation region of the laser light 2 comes into contact with the workpiece 20, that is, when the cutting begins. The x-coordinate, at this time, of the optical axis center of the laser light is denoted by x₁. When the feed mechanism further moves the laser light 2 at the constant speed v, the laser light 2 partially impinges on the workpiece 20. FIG. 4C shows a state when the cylindrical irradiation region of the laser light 2 partially impinges on the workpiece 20. The x-coordinate, at this time, of the optical axis center of the laser light is denoted by x₂.

The controller 13 according to the embodiment can, by identifying the coordinate x₁ when the cylindrical irradiation region of the laser light 2 begins to cut into the workpiece 20 as the origin coordinate, accurately identify the depth of cut of the subsequent laser pulse grinding.

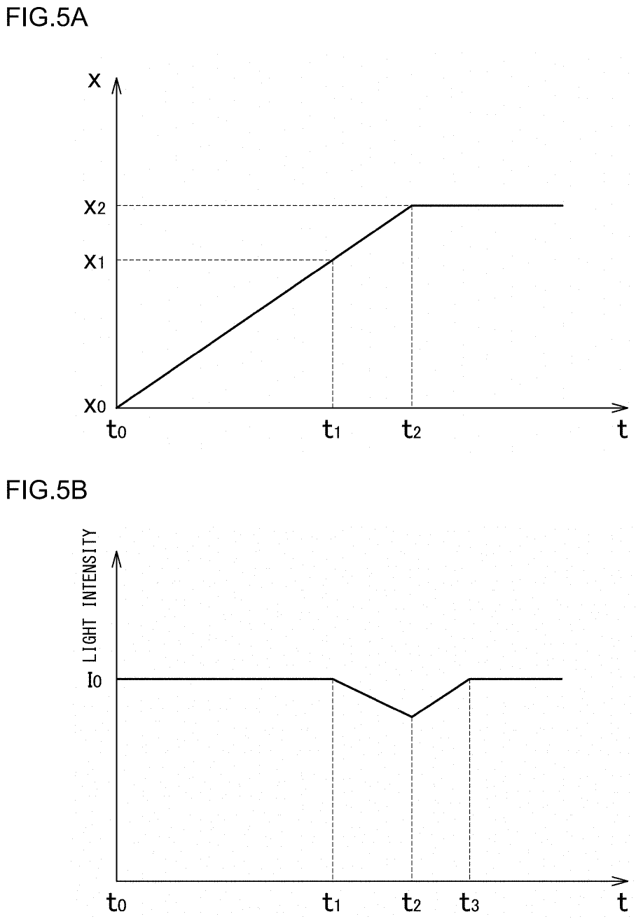

FIG. 5A shows changes in feed amount over time. FIG. 5A shows a feed motion of the laser light 2 in which the optical axis center moves at a constant speed from x₀ to x₂ in a period from time t₀ to time t₂ and then stops moving.

FIG. 5B shows changes, over time, in light intensity detected by the intensity detector 18. The controller 13 monitors the light intensity detected by the intensity detector 18. As shown in FIGS. 4A and 4B, while the optical axis center moves from x₀ to x₁ (that is, in the period from time t₀ and time t₁), the cylindrical irradiation region does not cut into, that is, does not come into contact with the workpiece 20, and thus the light intensity detected by the intensity detector 18 does not change from the initial value I₀ that is a reference value. When the light intensity remains constant at the initial value I₀, the controller 13 determines that the laser light 2 has not cut into the workpiece 20.

When the outermost peripheral portion of the cylindrical irradiation region of the laser light 2 begins to cut into the workpiece 20 at time t₁, the energy of the laser light that has cut into (penetrated) the workpiece 20 is used for machining the workpiece 20, and the light intensity detected by the intensity detector 18 decreases accordingly. The controller 13 determines, at the timing when the light intensity detected by the intensity detector 18 decreases from the initial value I₀, that the laser light 2 emitted from the laser light emitter 10 has begun to cut into the workpiece 20. In this example, at the timing of time t₁, that is, when the x-coordinate of the optical axis center becomes x₁ on the x-axis, the controller 13 determines that the outermost peripheral portion of the cylindrical irradiation region has begun to cut into the workpiece 20. This determination process corresponds to the so-called origin setting process, and the controller 13 can accurately set the depth of cut of the subsequent pulse laser grinding on the basis of the coordinate value of x₁.

Note that, in the example of the feed motion shown in FIG. 5A, the feed mechanism moves the optical axis center of the laser light 2 to x₂ and stops the optical axis center at x₂. As shown in FIG. 5B, in the period from time t₁ to time t₂, the light intensity detected by the intensity detector 18 gradually decreases as an area of the workpiece 20 irradiated with the laser light 2 increases. The decrease in light intensity from the initial value I₀ that is the reference value corresponds to a laser light quantity used for machining the workpiece 20, and this laser light quantity corresponds to energy used for eliminating the material of the workpiece 20. This allows the controller 13 to determine the laser light quantity used for machining the workpiece 20 by monitoring the decrease in light intensity from the initial value I₀ to estimate an elimination area of the workpiece 20 currently being machined.

When the elimination area of the workpiece 20 is estimated, the intensity detector 18 monitors fluctuations of the laser light intensity, and the controller 13 may take into account the fluctuations of the light intensity emitted toward the workpiece 20 to determine the laser light quantity used for machining. For example, the intensity detector 18 splits off, for monitoring the fluctuations of the light intensity, some from the laser light 2 to continuously monitor the light intensity. The controller 13 may calculate a fluctuation rate of the light intensity from a result of monitoring the light intensity, calculate an instantaneous value Io of the light intensity emitted toward the workpiece 20 using the fluctuation rate, and determine the laser light quantity used for machining the workpiece 20 by monitoring the decrease in light intensity from the emitted light intensity I₀. This allows the elimination area of the workpiece 20 to be estimated more accurately.

On the other hand, in a period from time t₂ to time t₃, the light intensity detected by the intensity detector 18 gradually increases and returns to a value close to I₀. When the feed motion of the laser light 2 is terminated at time t₂ (state shown in FIG. 4C), the material elimination by the laser light 2 proceeds in the traveling direction of the laser light 2 to eliminate the material, the laser light passing by (passing through) the workpiece 20 increases, and the light intensity detected by the intensity detector 18 gradually increases. Note that it is only necessary for the origin setting process to know time t₁ at which the light intensity decreases; therefore, the controller 13 may stop the operation of the feed mechanism at the time when the x coordinate (x₁) at time t₁ is identified.

When the cutting edge, to be machined, of the workpiece 20 has an arc shape, the origin setting process is preferably performed at a plurality of points or continuously along the cutting edge ridgeline of the workpiece 20. Setting the origin between the laser light 2 and the cutting edge ridgeline at a plurality of points allows the relative positional relationship between the laser light 2 and the cutting edge ridgeline of the workpiece 20 to be identified, and allows the laser machining apparatus 1 to perform cutting edge machining with high accuracy. Note that when the number of points at which the origin setting process is performed is equal to or greater than two, the inclination of the cutting edge ridgeline can be identified, and when the number is equal to or greater than three, the center position and radius of an arc-shaped cutting edge ridgeline can be identified.

During the origin setting process, the controller 13 may set the intensity of the laser light 2 output by the laser light emitter 10 lower than a level at which the workpiece 20 is machined with the laser light 2. Setting the laser light intensity during the origin setting process lower than the machining level prevents the laser light 2 from machining the workpiece 20, so that the intensity detector 18 can accurately measure, without depending on the feed speed, the intensity of laser light that has not impinged on the workpiece 20. This in turn allows the controller 13 to accurately derive the coordinate value of the origin and perform laser pulse grinding, with high accuracy, using the origin coordinate value. During the origin setting process, the controller 13 may set the intensity of the laser light 2 output by the laser light emitter 10 sufficiently low to the extent of not causing thermal damage to the workpiece 20.

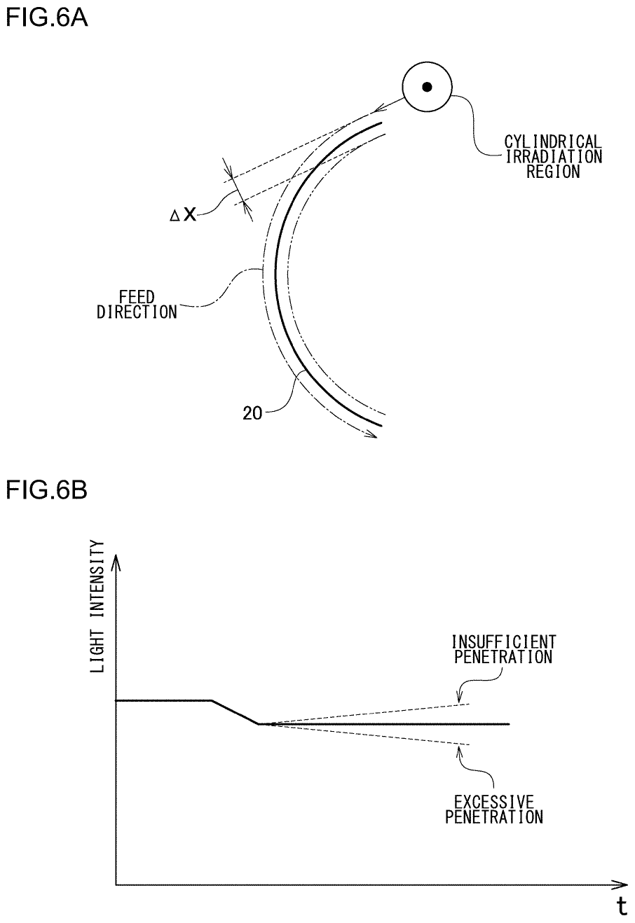

FIG. 6A shows an example of how the pulse laser grinding is performed. The controller 13 identifies the cutting edge ridgeline of the workpiece 20 after performing the origin setting process at a plurality of points and machines the cutting edge along the cutting edge ridgeline identified. In the example shown in FIG. 6A, the cylindrical irradiation region is caused to penetrate the cutting edge of the workpiece 20 by Δx, and the cylindrical irradiation region is moved along the cutting edge ridgeline at a constant feed speed.

FIG. 6B shows changes, over time, in light intensity during the pulse laser grinding. When the laser machining apparatus 1 machines the cutting edge at a constant feed speed, the penetration amount (Δx) of the cylindrical irradiation region is constant along the cutting edge ridgeline, and the thickness of the workpiece in the optical axis direction of the laser light is constant over all penetration depth positions, the light intensity detected by the intensity detector 18 becomes constant. This state is represented by a solid line. On the other hand, as the penetration amount gradually decreases along the cutting edge ridgeline (insufficient penetration), the light intensity detected by the intensity detector 18 gradually increases, whereas as the penetration amount gradually increases along the cutting edge ridgeline (excessive penetration), the light intensity detected by the intensity detector 18 gradually decreases. As described above, the controller 13 can determine whether the pulse laser grinding is properly performed by monitoring the light intensity during the pulse laser grinding. Note that when the light intensity suddenly increases during the monitoring of the light intensity, the controller 13 may determine that chipping occurs in the cutting edge.

The present disclosure has been described on the basis of the examples. It is to be understood by those skilled in the art that the examples are illustrative and that various modifications are possible for a combination of components or processes, and that such modifications are also within the scope of the present disclosure.

An outline of aspects of the present disclosure is as follows. One aspect of the present disclosure is a machining apparatus structured to scan a cylindrical irradiation region including a focused spot of laser light to machine a workpiece and including a feed mechanism structured to move the workpiece relative to the cylindrical irradiation region of the laser light, a light receiver structured to receive laser light that has not impinged on the workpiece, an intensity detector structured to detect intensity of the laser light received, and a controller structured to identify a relative positional relationship between the laser light and the workpiece on the basis of the light intensity detected.

The use of the fact that laser light not used for eliminating the material of the workpiece during the pulse laser grinding passes by without impinging on the workpiece allows the controller to identify the relative positional relationship between the laser light and the workpiece on the basis of the intensity of the laser light which has passed by the workpiece. For example, with the light intensity when the laser light does not penetrate the workpiece denoted by I₀, when the light intensity does not change from Io even when the feed mechanism brings the workpiece closer to the cylindrical irradiation region of the laser light, the controller may determine that the laser light is in out of contact with the workpiece.

The controller may determine, at timing when the light intensity detected decreases, that the laser light has begun to cut into the workpiece. When identifying the relative positional relationship, the controller may set the intensity of the laser light lower than a level at which the workpiece is machined with the laser light. The controller may identify the relative positional relationship between the laser light and the cutting edge ridgeline of the workpiece.

Another aspect of the present disclosure is a machining apparatus structured to scan a cylindrical irradiation region including a focused spot of laser light to machine a workpiece and including a feed mechanism structured to move the workpiece relative to the cylindrical irradiation region of the laser light, a light receiver structured to receive laser light that has not impinged on the workpiece, an intensity detector structured to detect intensity of the laser light received, and a controller structured to determine a quantity of laser light used for machining the workpiece on the basis of the light intensity detected.

The controller can monitor a machining state of the workpiece by determining the quantity of laser light used for machining the workpiece.

Yet another aspect of the present disclosure is a method for identifying, in a machining apparatus structured to scan a cylindrical irradiation region including a focused spot of laser light to machine a workpiece, a relative positional relationship between the laser light and the workpiece, the method including moving the workpiece relative to the cylindrical irradiation region of the laser light, receiving laser light that has not impinged on the workpiece, detecting intensity of the laser light received, and identifying the relative positional relationship between the laser light and the workpiece on the basis of the light intensity detected.

Yet another aspect of the present disclosure is a method for determining, in a machining apparatus structured to scan a cylindrical irradiation region including a focused spot of laser light to machine a workpiece, a quantity of laser light, the method including moving the workpiece relative to the cylindrical irradiation region of the laser light, receiving laser light that has not impinged on the workpiece, detecting intensity of the laser light received, and determining a quantity of laser light used for machining the workpiece on the basis of the light intensity detected.

What is claimed is:

1. A machining apparatus that scans a cylindrical irradiation region including a focused spot of laser light to machine a workpiece, the machining apparatus comprising:
a feed mechanism structured to move the workpiece relative to the cylindrical irradiation region of the laser light;
a light receiver structured to receive the laser light;
an intensity detector structured to detect intensity of the laser light received; and
a controller structured to determine, at timing when the light intensity detected decreases, that the laser light has begun to cut into the workpiece.

2. The machining apparatus according to claim 1, wherein
the controller sets the intensity of the laser light lower than a level at which the workpiece is machined with the laser light.

3. The machining apparatus according to claim 1, wherein
the controller identifies a relative positional relationship between the laser light and a cutting edge ridgeline of the workpiece on the basis of the light intensity detected.

4. A machining apparatus that scans a cylindrical irradiation region including a focused spot of laser light to machine a workpiece, the machining apparatus comprising:
a feed mechanism structured to move the workpiece relative to the cylindrical irradiation region of the laser light;
a light receiver structured to receive the laser light;
an intensity detector structured to detect intensity of the laser light received; and
a controller structured to determine a quantity of laser light used for machining the workpiece on the basis of the light intensity detected.

5. The machining apparatus according to claim 4, wherein
the controller determines, at timing when the light intensity detected decreases, that the laser light has begun to cut into the workpiece.

6. A method for identifying, in a machining apparatus that scans a cylindrical irradiation region including a focused spot of laser light to machine a workpiece, a relative positional relationship between the laser light and the workpiece, the method comprising:
moving the workpiece relative to the cylindrical irradiation region of the laser light;
receiving the laser light;
detecting intensity of the laser light received; and
determining, at timing when the light intensity detected decreases, that the laser light has begun to cut into the workpiece.

7. A method for determining, in a machining apparatus that scans a cylindrical irradiation region including a focused spot of laser light to machine a workpiece, a quantity of laser light, the method comprising:
moving the workpiece relative to the cylindrical irradiation region of the laser light;
receiving the laser light;
detecting intensity of the laser light received; and
determining a quantity of laser light used for machining the workpiece on the basis of the light intensity detected.
